(19) United States
(12) Patent Application Publication
(10) Pub. No.: US 2024/0029117 A1
(43) Pub. Date: Jan. 25, 2024

(54) SYSTEMS, METHODS, AND DEVICES FOR A DYNAMICALLY MANAGEABLE QR DRIVEN INFORMATION PLATFORM

(71) Applicant: GoDocent Inc., Millbrae, CA (US)

(72) Inventors: Michael Jimenez, Santa Cruz, CA (US); Themistocles Chilicas, Millbrae, CA (US)

(21) Appl. No.: 17/872,351

(22) Filed: Jul. 25, 2022

(51) Int. Cl. G06Q 30/02; G06K 19/06

(52) U.S. Cl. CPC G06Q 30/0276; G06K 19/06037; G06K 2019/06253

(57) ABSTRACT

Techniques, described herein, enable a dynamically manageable quick response (QR) driven information platform. The platform may enable users to create pin pages for products, services, events, etc. Creating a pin page may include associating a web page with a customized QR code and designing the pin page to include images, videos, text, hyperlinks, or other types of information. The QR code may be presented at, for example, tradeshow booths, social network environments, political interest event, and/or one or more other scenarios, and users may use a smartphone to access the pin page via the QR code. Users may also create an account, which may be used to save or “like” pin pages, access additional information about the pin page, create a registry of contacts or “friends”, share pin pages with others, etc. Additional features of the techniques are described herein.

### FIELD

This disclosure relates to computerized networks and information systems.

### BACKGROUND

Computerized networks may include a variety of systems, devices, and technologies to enable users to create, store, access, and distribute information. Such networks may include one or more wired networks, wireless networks, or a combination thereof. Each network may include a broad range of interconnected devices, each comprising hardware, software, virtualization technology, etc., which enables the devices to send, receive, process, and/or store information. Examples of such devices may include mobile user devices (e.g., cell phones, tablet computers, laptop computers, etc.) stationary devices (e.g., desktop computer, servers, etc.), and network components and devices (e.g., network hubs, routers, base stations, satellite systems, etc.). The network may be used to enable a variety of network services, such as user-to-user communications, social networking for personal and professional reasons, institutionalized information distribution and publishing, online marketing, online banking and investing, academic and scientific research, and more.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example overview according to one or more implementations described herein.

FIG. 2 is a diagram of an example network according to one or more implementations described herein.

FIG. 3 is a diagram of an example user equipment (UE) according to one or more implementations described herein.

FIG. 4 is a diagram of an example of functionalities of a pin pages platform according to one or more implementations described herein.

FIG. 5 is a diagram of an example process for creating and managing a pin page according to one or more implementations described herein.

FIG. 6 is a diagram of an example user interface for creating a pin page account according to one or more implementations described herein.

FIGS. 7-10 are diagrams of example user interfaces for creating a pin page FIGS. 7-10 are diagrams of example user interfaces for 700-1000 creating a pin page and customized QR code according to one or more implementations described herein.

FIG. 11 is a diagram of an example of a published pin page according to one or more implementations described herein.

FIG. 12 is a diagram of an example user interface for managing a pin page according to one or more implementations described herein.

FIG. 13 is a diagram of an example user interface for managing multiple pin pages of a pin page account according to one or more implementations described herein.

FIG. 14 is a diagram of an example data structure of a pin page according to one or more implementations described herein.

FIG. 15 is a diagram of an example data structure for associating customized quick response (QR) codes with pin pages according to one or more implementations described herein.

FIG. 16 is a diagram of an example process for accessing and interacting with a pin page according to one or more implementations described herein.

FIG. 17 is a diagram of an example of a pin page 1700 according to one or more implementations described herein.

FIG. 18 is a diagram of an example user interface for managing saved pin pages according to one or more implementations described herein.

FIG. 19 is a diagram of an example user interface for managing user connections according to one or more implementations described herein.

FIG. 20 is a diagram of an example data structure of a pin page account according to one or more implementations described herein.

FIG. 21 is a diagram of an example process for managing a pin page platform according to one or more implementations described herein.

FIG. 22 is a diagram of example components of a device that may be used within environment of FIG. 2.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Techniques, described herein, may enable a dynamically manageable quick response (QR) driven information platform. While one or more of the techniques may be presented within the context of a tradeshow environment or scenario, such descriptions are provided as non-limiting examples and implementations. Indeed, one or more of the techniques, described herein, may be applicable to environments and scenarios beyond, outside of, or excluding a tradeshow environment or scenario. Non-limiting examples of such scenarios may include social networking scenarios, business development scenarios, public relations scenarios, social or political awareness scenarios, and more. References to tradeshow implementations are therefore provided to facilitate the more fundamental features, solutions, benefits, etc., that fall within the broader scope of the techniques (e.g., systems, methods, and devices) describe herein.

A tradeshow may include an exhibition organized so that companies or organizations of a specific industry or interest may showcase and demonstrate products and services, meet with potential partners and customers, study activities of rivals, and examine recent market trends and opportunities. The platform may be referred to herein as a pin page platform. A user may create an account on the platform (referred to herein as a pin page account) and create one or more pin pages associated with the account. Creating a pin page may include designing a mobile friendly, templatized webpage with certain content (e.g., images, videos, text, hyperlinks, virtual cards (v-cards), payment portals, or other types of information corresponding to a product or service) and associating the webpage with a customized quick response (QR) code (e.g., a QR code customized according to a product, service, organization, etc.). A pin page may be designed to promote products, services, events, etc., that the user intends to share, promote, or otherwise make available (e.g., at the tradeshow).

For example, the customized QR code may be presented to tradeshow attendees (e.g., at a presenter's booth, via a flyer or handout, displayed on a screen, etc.) and attendees may use a personal mobile device (e.g., a smartphone) to scan the QR code and access the pin page. The pin page platform may also enable attendees to create a pin page accounts, which may be used to create pin pages of their own, save, share, or “like” pin pages, access information, receive updates, pay a vendor, receive or “push” prompts or other notification, and so on. The pin page platform may also process and analyze information collected (also referred to herein as pin page activity information). Examples of such information may relate to determining which pin pages were accessed, when, and by whom, a level of popularity of different platform features or functions, etc. Accordingly, one or more of the techniques described herein may enable users of a pin page platform to dynamically create, access, and manage QR driven pin pages. The foregoing features, and others, are described in further detail below with reference to the figures that follow.

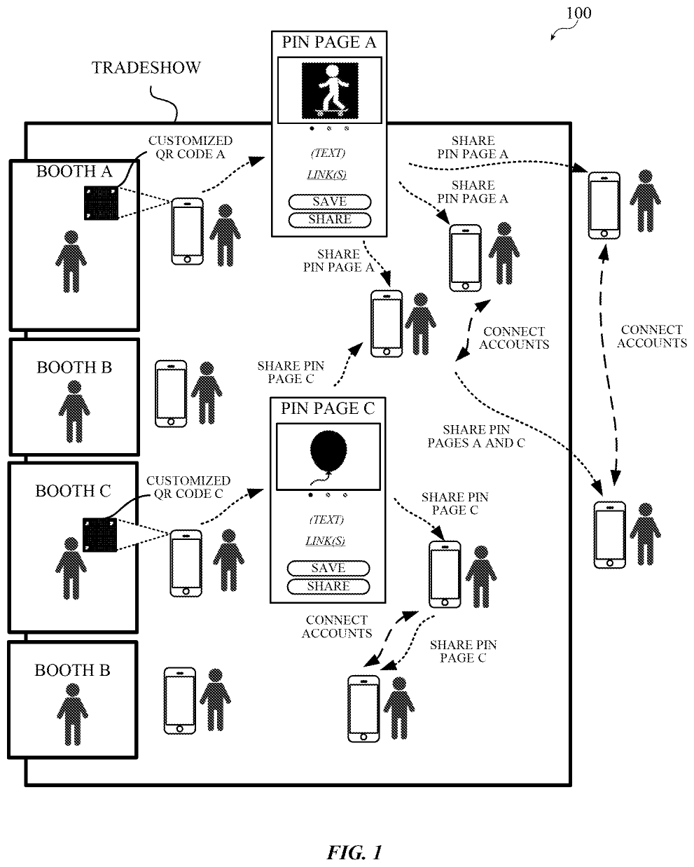

FIG. 1 is a diagram of an example overview 100 according to one or more implementations described herein. As shown, a tradeshow may include a variety of booths, e.g., booths A-D. Each booth may represent a product, service, organization, or other interest, and each booth may be staffed include one or be staffed by a booth representative. Some booths may include a picture, printout, or other display of a customized QR code associated with the booth. The customized QR code functions as a traditional QR code but is enhanced by including a trademark, logo, or other visual preferences. The customized QR code may be digitally associated with a pin page that includes imagines, videos, text information, and other information about the product, service, organization, or interest. The pin page may also include hyperlinks to webpages, buttons for accessing other functionality, and other types of interface features. For example, pin page may be created, hosted, and provided by a pin page platform.

The pin page platform may enable anyone (e.g., even users without a pin page platform account) to view pin pages after scanning customized QR codes. Users with a pin page platform account may also be able to create a user profile, display a user profile place to other users on the platform, become connected with the user profiles of other users (also referred to herein as “connected users”), create private and public social network groups, message and forward pin pages to connected users, and more. The pin page platform may also enable users to create pin pages, associate pin pages with customized QR codes, instantly edit or modify pin pages, push update messages to users that have “liked”, “favorited”, or “saved” the pin pages, and so on. These and other features are described below in greater detail with reference to the figures that follow

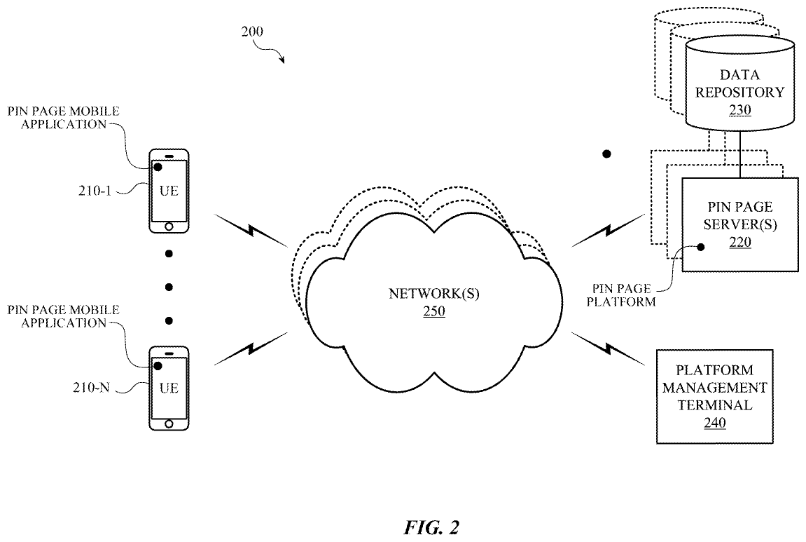

FIG. 2 is a diagram of an example environment 200 in which systems and/or methods, described herein, may be implemented. As depicted, environment 200 may include user equipment (UE) 210-1, . . . 210-N (where N is greater than or equal to 2 and collectively referred to as “UEs 210”), pin page servers 220, data repositories 230, platform management terminal 240, and network 250. The number of devices and/or network, illustrated in FIG. 2, is provided for explanatory purposes only. In practice, there may be additional devices and/or networks, fewer devices and/or networks, different devices and/or networks, or differently arranged devices and/or networks than illustrated in FIG. 2.

Also, in some implementations, one or more of the devices of environment 200 may perform one or more functions described as being performed by another one or more of the devices of environment 200. Devices of environment 200 may interconnect via wired connections, wireless connections, or a combination of wired and wireless connections.

UE 210 may include any type computing device, such as a wireless mobile communication device, that is capable of communicating with network 250. For example, UE 210 may include a smartphone, tablet computer, laptop computer, wearable device, etc. In some implementations, UE 210 may alternatively include a desktop computer, a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a laptop computer, a tablet computer, a camera, a personal gaming system, a smart phone, or another type of computation or communication device. UE 210 may include a camera or another type of image capturing capability for detecting and processing QR codes.

Pin page servers 220 may include one or more servers or other types of computing devices capable of gathering, processing, searching for, storing, and/or communication information as described herein. In some implementation, pin page servers 220 may include an application server or a web server that stores one or more applications and/or that permits the one or more applications to be accessed and/or downloaded by UEs 210. Pin page servers 220 may include a single server device, group of server devices, and/or one or more virtual servers. In some implementations, pin page servers 220 may comprise a pin page platform as described herein. In some implementations, pin page servers 220 in combination with one or more other types of devices, e.g., UEs 210, data repositories, platform management terminals 240, etc., may comprise a pin page platform. Pin page servers 220 may include, or be connected to, one or more data repositories 230.

Data repositories 230 may include one or more data storage devices capable of receiving, storing, and providing data related to pin pages, pin page accounts, pin page usage information, etc. In some implementations, data repositories 230 may include a database or another type of data storage system or framework for organizing and storing data. In some implementations, pin page servers 220 and data repositors 230 may be connected via network 250. Platform management terminal 240 may include type of wired or wireless user device capable of communicating with pin page servers 220 and/or data repositories 230 via network 250. Platform management terminal 240 may include a smartphone, tablet computer, laptop computer, desktop computer, or another type of user device capable of enabling a user, operator, or developer to interact with pin page servers 220 and/or the pin page platform as described herein. In some implementations, platform management terminal 240 may be a UE 210. Additionally, or alternatively, platform management terminal 240 may be directly connected to pin page servers 220.

Network 250 may include a single network or multiple networks capable of enabling a connection between the devices of FIG. 2. Network 250 may include one or more wired and/or wireless networks. For example, network 250 may include a Bluetooth® network, a Wi-Fi network, or a cellular network, the Public Land Mobile Network (PLMN), and/or a second generation (2G) network, a third generation (3G) network, a fourth generation (4G) network, a fifth generation (5G) network, a sixth generation (6G) network and/or another type of network. Additionally, or alternatively, network 250 may include a wide area network (WAN), a metropolitan area network (MAN), an ad hoc network, an intranet, the Internet, a virtual network (e.g., a virtual private network (VPN)), a telephone network (e.g., a Public Switched Telephone Network (PSTN)), a Voice over IP (VoIP) network, and/or a combination of these or other types of networks.

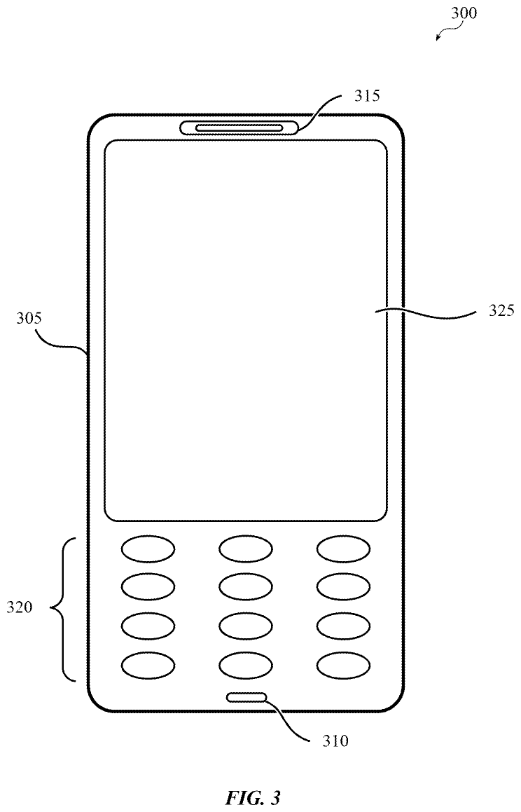

FIG. 3 is a diagram of an example UE 210. As illustrated in FIG. 3, UE 210 may include a housing 305, a microphone 310, a speaker 315, a keypad 320, and a display 325. Although FIG. 3 shows example components of UE 210, in other implementations, UE 210 may include fewer components, different components, differently arranged components, or additional components than depicted in FIG. 3. For example, in some implementations, UE 210 may include one or more cameras or other types of optical sensors. Alternatively, or additionally, UE 310 may incorporate functionality of keypad 320 and display via a touchable display.

Housing 305 may include a structure to contain components of UE 310. For example, housing 305 may be formed from plastic, metal, or some other material. Housing 305 may support microphone 310, speakers 315, keypad 320, and display 325. Microphone 310 may include an input device that converts a sound wave to a corresponding electrical signal. For example, the user may speak into microphone 310 during a telephone call or to execute a voice command Speaker 315 may include an output device that converts an electrical signal to a corresponding sound wave. For example, the user may listen to music, listen to a calling party, or listen to other auditory signals through speaker 315.

Keypad 320 may include an input device that provides input into UE 210. Keypad 320 may include a standard telephone keypad, a QWERTY keyboard, and/or some other type or arrangement of keys. Keypad 320 may also include one or more special purpose keys. The user may utilize keypad 320 as an input component to UE 210. For example, the user may use keypad 320 to enter information, such as alphanumeric text, to access data, or to invoke a function or an operation.

Display 325 may include an output device that outputs visual content, and/or may include an input device that receives user input (e.g., a touch screen (also known as a touch display)). Display 325 may be implemented according to a variety of display technologies, such as, a liquid crystal display (LCD), a plasma display panel (PDP), a field emission display (FED), a thin film transistor (TFT) display, or some other type of display technology. Additionally, display 325 may be implemented according to a variety of sensing technologies, such as, capacitive sensing, surface acoustic wave sensing, resistive sensing, optical sensing, pressure sensing, infrared sensing, gesture sensing, etc. Display 325 may display text, images, and/or video to the user. Display 325 may also display a user interface (e.g., a graphical user interface (GUI)) of UE 210 or a user interface of some other device which UE 210 controls, a user interface associated with applications, or the like.

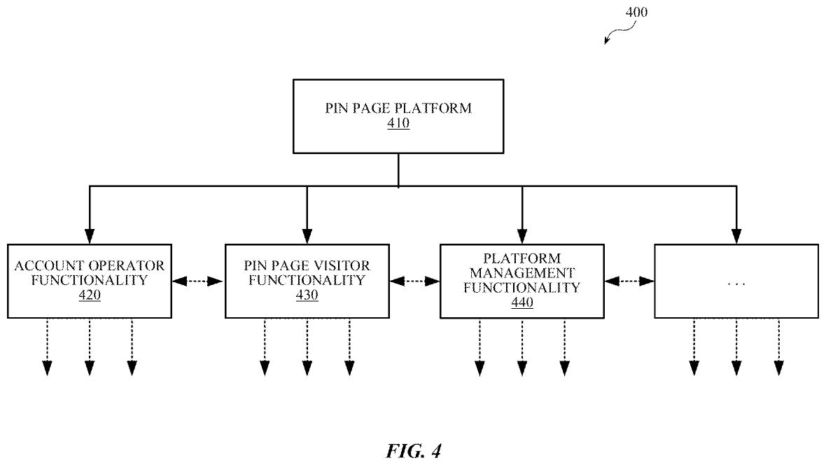

FIG. 4 is a diagram of an example 400 of functionalities of a pin pages platform according to one or more implementations described herein. As shown, pin page platform 410 may include account operator functionality 420, pin page visitor functionality 430, and platform management functionality 440. In some implementations, one or more of functionalities 420, 430, and 440, may be performed by one or more of UE 210, page server 220, and/or platform management terminal 240, and/or one or more other types of device of FIG. 2. Additionally, pin page platform 410 may include one or more fewer, additional, differently ordered and/or arranged groups of functionality than those shown in FIG. 4. As such, FIG. 4 is provided as a non-limiting example of pin page platform 410 and an arrangement of operations, functions, and services thereof.

Functionalities 420, 430, and 440 may each represent operations, functions, and services supported by pin page platform 410. For example, account operator functionality may include operations for creating a pin page account, creating pin pages for the pin page account, monitoring usage of the pin pages, and so on. Pin page visitor functionality 430 may include operations for enabling an individual to scan a QR code, access a corresponding pin page, share the pin page with others, etc. Platform management functionality 440 may include operations for managing pin page accounts, pin pages, security and user verification functionality, data collection, storage, and processing, etc. Additionally, or alternatively, one or more portions or aspects of functionalities 420, 430, and 440, may interrelate or overlap with that of one or more other portions or aspects of functionalities 420, 430, and 440. Each of functionalities 420, 430, and 440 are described below in greater detail with reference to the figures that follow.

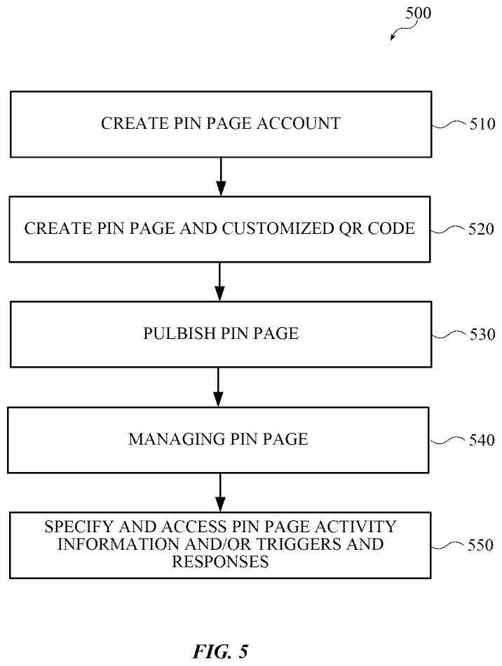

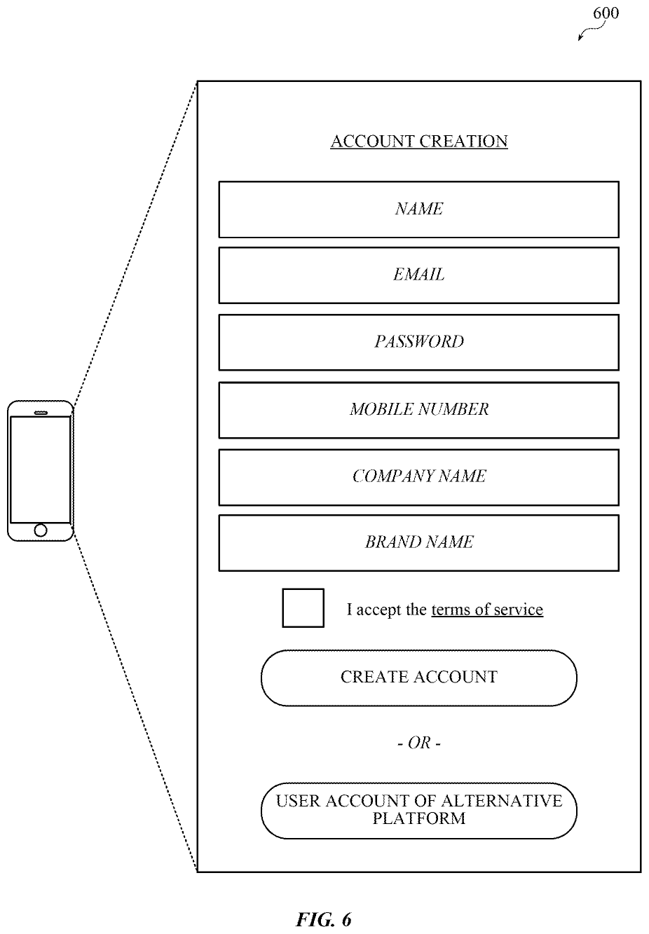

FIG. 5 is a diagram of an example process 500 for creating and managing a pin page according to one or more implementations described herein. Process 500 may be implemented by UE 210. In some implementations, some or all of process 500 may be performed by one or more other systems or devices, including one or more of the devices of FIG. 2. Additionally, process 500 may include one or more fewer, additional, differently ordered and/or arranged operations than those shown in FIG. 5. In some implementations, some or all of the operations of process 500 may be performed independently, successively, simultaneously, etc., of one or more of the other operations of process 500. As such, the techniques described herein are not limited to a number, sequence, arrangement, timing, etc., of the operations or process depicted in FIG. 5. Process 500 is described below with periodic reference to FIGS. 6-13. User input, as described herein, may include commands, selections, instructions, and/or other types of information input by a user into UE 210.

As shown, process 500 may include creating a pin page account (block 510). For example, UE 210 may communicate with pin page server 220 to via a mobile application, browser, etc., to access a webpage or another type of interfaces for creating a pin page account. In some implementations, the interface may be accessed by, for example, opening a mobile application installed on UE 210, entering a Uniform Resource Locator (URL) address into a browser of UE 210, and/or in response to another type of trigger.

FIG. 6 is a diagram of an example user interface 600 for creating a pin page account according to one or more implementations described herein. In some implementations, one or more of the features of user interface 600 may be provided via one or more additional or alternative user interfaces. Additionally, one or more of the features of user interface 600 may include fewer, additional, differently ordered and/or arranged features than those shown in FIG. 6. The examples of user interfaces, 600-1300 and 1700-1900 are non-limiting examples of user interfaces that may be involved in one or more implementations described herein.

A user interface for creating a pin page account may include one or more interface objects, such as text boxes, dropdown menus, radio buttons, pressable buttons, check boxes, URLs, instructions, prompts, graphics, etc., to enable or facilitate the creation of a pin page account. As shown, user interface 600 may include text boxes for entering user information, such as a username, email address, password, mobile number, company name, brand name, etc. User interface 600 may also include interface features for accessing terms of service (e.g., via a URL) and indicating acceptance of the terms of service (e.g., a check box). In some implementations, a user may create a pin page account by filling in such information and selecting a “create account” button or by selecting a button to login to into an account the user may have on an alternative platform (e.g., a social media account). In such a scenario, the pin page platform may retrieve user information from the alternative platform and automatically create a pin page account for the pin page platform. A pin page account may also be referred to herein as a pin page user account, a user account, and the like.

Referring to FIG. 5, process 500 may also include creating a pin page and customized QR code (block 520). For example, UE 210 may communicate with pin page server 220 to create a pin page. In some implementations, this may include specifying a name for the pin page, providing a logo, images, text, hyperlinks, and other content for the pin page. Additionally, creating a pin page may include customizing a QR code for the pin page, which may include specifying features of the QR code, a logo for the QR code, a color of the QR code, secondary messaging on the border of the QR code, etc. Secondary messaging may include information incorporated into the QR code that provides additional information, design, or customization without forfeiting the functionality of the QR code itself. This may also include downloading an image of the customized QR code, from which the user may create digital or hardcopies to include in booth displays, distributable media (e.g., flyers or pamphlets), and other promotions/advertising etc.

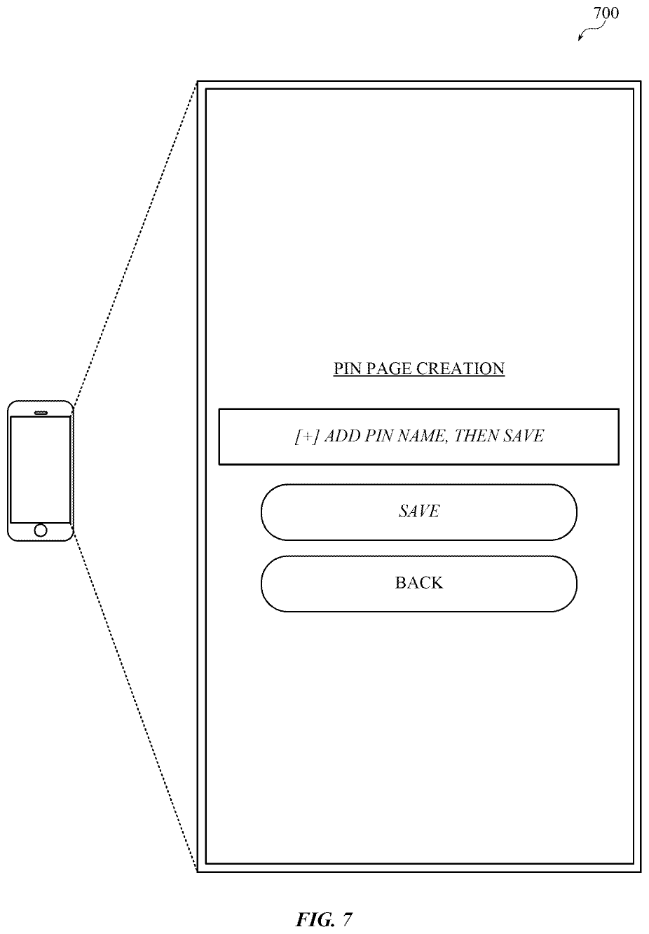

FIGS. 7-10 are diagrams of example user interfaces 700-1000 for creating a pin page and customized QR code according to one or more implementations described herein. In some implementations, one or more of the features of user interfaces 700-1000 may be provided via one or more additional or alternative user interfaces. Additionally, one or more of the features of user interface 700-1000 may include fewer, additional, differently ordered and/or arranged features than those shown in FIG. 7-10.

A user interface for creating a pin page may include one or more interface objects, such as text boxes, dropdown menus, radio buttons, pressable buttons, check boxes, URLs, instructions, prompts, graphics, etc., to enable or facilitate the creation of a pin page account. As shown, user interface 700 may include a text box for entering a name of the pin page to be created and pressable buttons for saving the pin page name and/or moving back to another user interface page, such as an account management interface, account activity interface, etc. Saving a pin page name may lead to a user interface for specifying features of the pin page. In some implementations, the pin page platform may also enable a pin page URL to include a customized or “vanity” URL. An example of a customized URL, as described herein, may include a URL that is functional in terms of enabling users to access the corresponding pin page yet also includes additional information (e.g., text, images, etc.) selected by the creator of the pin page.

As shown, user interface 800 may include a functional template for a pin page. For instance, user interface 800 may include an area that enables a user to enter a logo or another type of information relating to the product, service, event, or promotion of the pin page. User interface 800 may also include an area to enable the user to upload an image, a graphics interchange format (gin file, a video link, etc., to the pin page. User interface 800 may also include an area to enable the user to enter text and links (ULRs) regarding the product, service, event, or promotion of the pin page.

User interface 800 may also include an area to enable the user to create one or more pressable buttons or other types of executable interface objects. Examples of such buttons may include links to additional information, such as a product owner's manual, browser-accessible products page, etc. Additionally, or alternatively, user interface 800 may include a representation of other interface objects included by default, such as an arrow type icon representing an ability of a pin page visitor to “share” the pin page with other users, a heart, thumbs up, etc., icon representing an ability of a pin page visitor to add the pin page to a list of pin page favorites of the pin page visitor, and a menu icon (e.g., indicated by three parallel lines) representing an ability of a pin page visitor to access pin page options. Examples of pin page options (or a menu of options) may include creating a brand account, accessing user account information, purchasing additional pin page services (e.g., additional pin pages), and accessing a favorites library (e.g., of pin pages previously identified by a user as being saved, “liked”, etc.

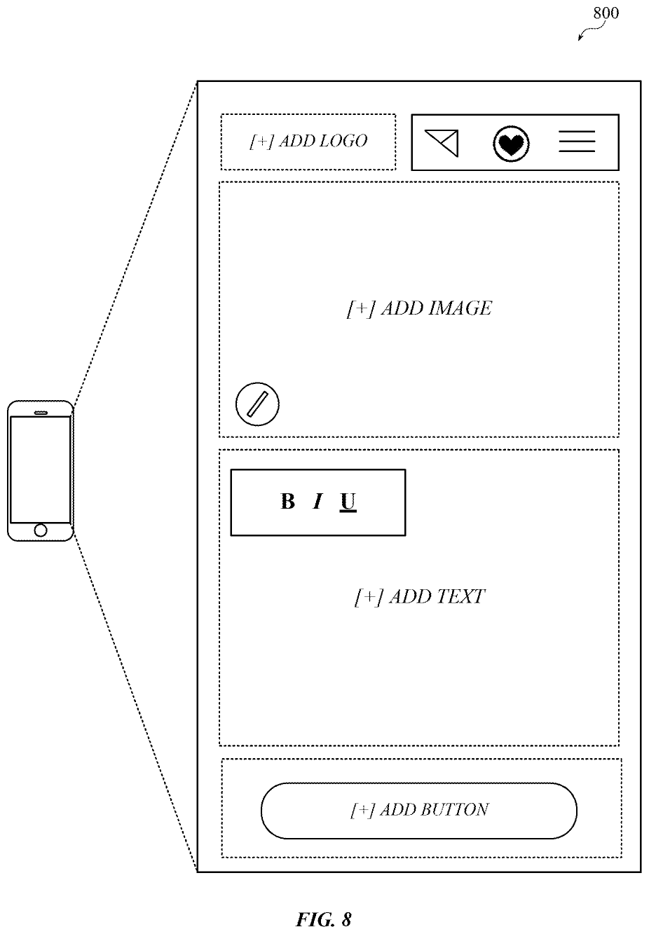

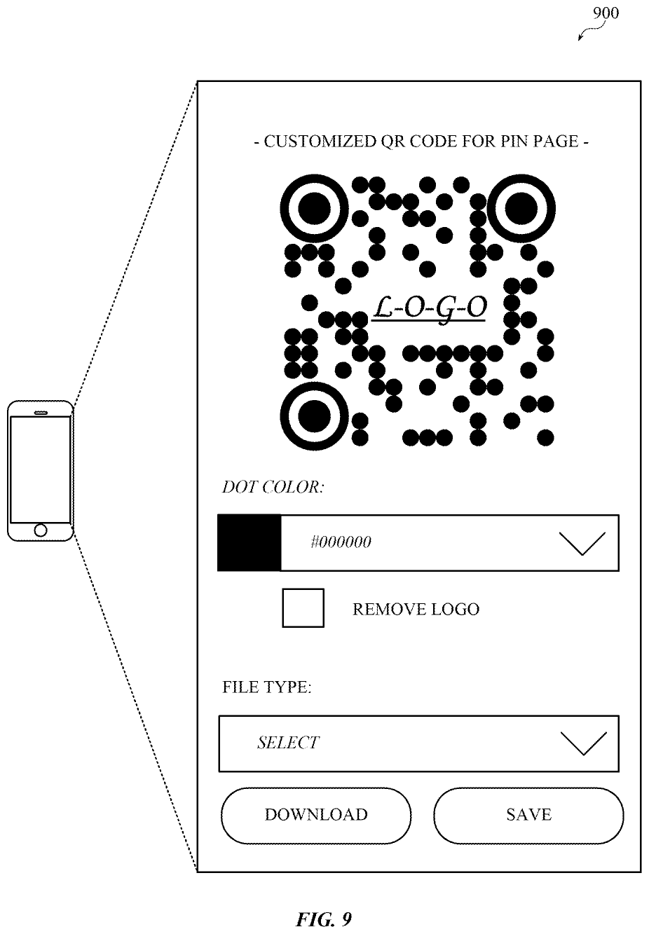

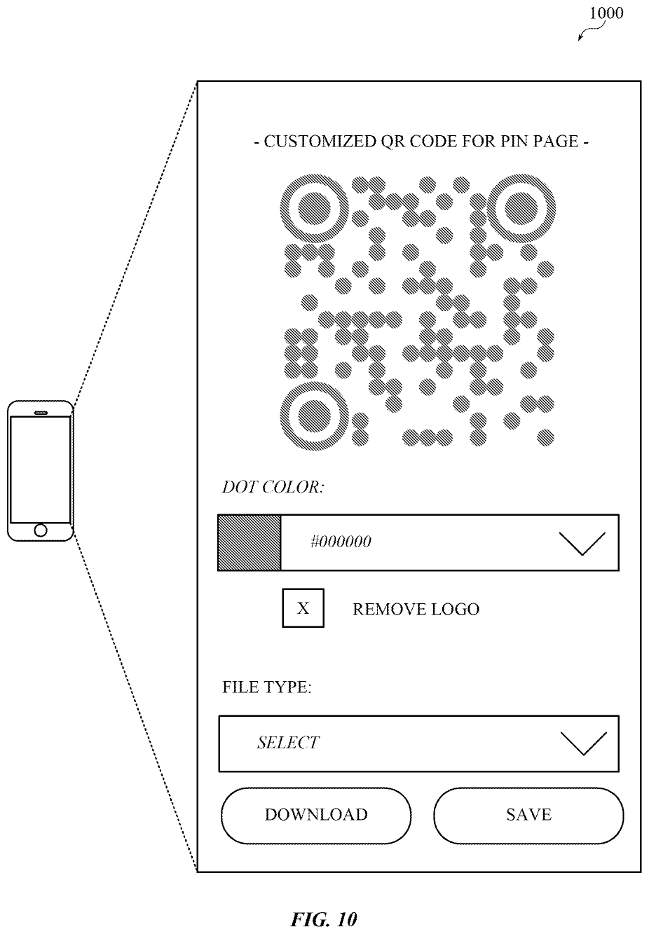

Referring to FIG. 9, user interface 900 may include features for customizing a QR code for the pin page and causing pin page platform to logically associate the pin page with the customized QR code. The pin page platform may present a QR code to the user, and user interface 900 may enable the user to customize the QR code. User interface 900 may include a dropdown menu for specifying a color of the features (e.g., dots, boxes, etc.) of the QR code and a dropdown menu for selecting and uploading a logo file or other image to be inserted into the QR code (e.g., “L-O-G-O”). In some implementations, the logo file or other QR code customization may be implemented above the QR code—e.g., the QR code may be included in the user interface and the logo or other customizations may be superimposed, overlaid, etc., above the QR code. Additionally, or alternatively, one or more of these characteristics may be included, inserted, or superimposed automatically. For example, the pin page platform may automatically insert a logo above (or into) the QR code based on logo information provided previously (e.g., via user interface 800 of FIG. 8). In such a scenario, user interface 900 may include a check box for removing the logo from the QR code. Additionally, or alternatively, user interface 900 may enable the user to specify whether the QR code is to include dots (as shown in FIG. 9) or boxes per a more traditional QR code format. User interface 900 may include a pressable button to enable the user to save a customized QR code, a dropdown menu and corresponding download button for downloading a copy of the customized QR code according to a file type specified by the user. This may enable the user to include display or otherwise include physical copies of the customized QR code in a booth presentation or distributable flyers, pamphlets, or other hardcopy forms of media. FIG. 10 includes a user interface 1000 that is similar to user interface 900 of FIG. 9, but with the dots and features of the customized QR code having a different shade or color, and the logo being removed. In some implementations, interfaces 9, 10, and/or one or more additional or alternative interfaces may enable a user to add an additional or secondary message (or customization) to the QR code. For example (while not shown), the additional customization may include a pre-selected number of alphanumeric characters to be added to one or more borders (e.g., a top, left, right, and/or bottom border) of the customized QR code. In some implementations, the QR code, and corresponding border, may include an overall circular shape.

Referring to FIG. 5, process 500 may include publishing and managing the pin page (block 530 and 540). For example, upon creating the pin page and customized QR code, UE 210 may communicate with pin page server 220 to cause the pin page to publish and manage the pin page. Publishing the pin page may include causing pin page server 220 to make the pin page accessible by UEs 210 that scan the customized QR code. Managing the pin page may include the user, to which (this sentence is a little confusing) the pin page account of the pin page corresponds, interacting with pin page server 220, via UE 210, to update, change, remove, etc., the pin page.

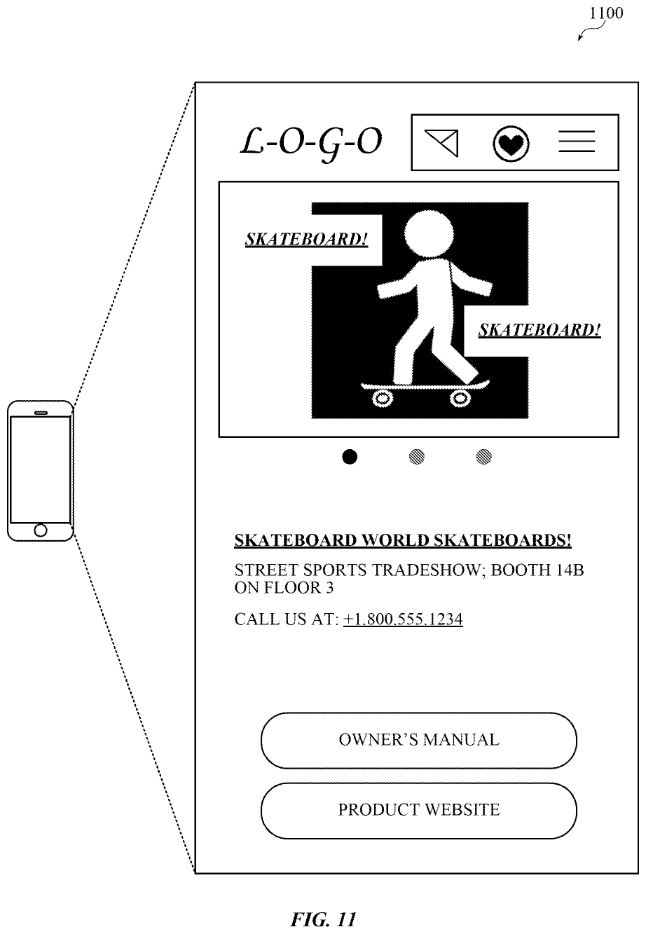

FIG. 11 is a diagram of an example of a published pin page 1100 according to one or more implementations described herein. The pin page of FIG. 11 may include features and information designated by the user during the creation of the pin page. Examples of such features and information may include a logo, an area displaying an image (e.g., an individual on a skateboard with the words “Skateboard!”), and a prompt (e.g., circles below the image) for a pin page visitor to scroll or “swipe” between additional images and/or videos of the pin page. Additional examples may include text and executable links to information, such as “Skateboard World Skateboards !”, a description of the tradeshow and corresponding booth location, and contact information. The published pin page 1100 may also include buttons that a pin page visitor may press to access additional information (e.g., an owner's manual, a product webpage, etc.), to order a product or service, find out more about the product or service, or perform one or more other actions. Published pin page 110 may also include pressable buttons for sharing the pin page with other users (e.g., indicated by the arrow-like or triangular icon of pin page 1100), a button for including the pin page in a list of pin page favorites of a pin page platform account of the user visiting the pin page (e.g., indicated by a heart symbol of pin page 1100), and an options icon (indicated by three horizontal lines). Examples of pin page options, a menu, etc., may include creating a brand account, accessing user account information, purchasing additional pin page services (e.g., additional pin pages), and accessing a favorites library (e.g., of pin pages previously identified by a user as being saved, “liked”, etc.

In some implementations, the product webpage, a corresponding company website, etc., may also be designed and/or hosted using the pin page platform of pin page server 220, and similar tools and features may be available to a pin page account owner to design, publish, edit, and manage such websites. In some implementations, the pin page platform may enable a pin page account owner to cause pin pages and corresponding webpages and services (e.g., product webpages, product purchasing interfaces, company webpages, marketing webpages, etc.) to be logically coupled and functionally interconnected such that updates or changes to a pin page, for example, may trigger automatic and corresponding changes to one or more webpages. For example, a pin page owner that updates a pin page to include a product sale of specified terms (e.g., an X % reduction in price of product Y for the next Z duration) may trigger an automatic update of the product webpage and product purchase interface on the pin page platform of pin page servers 220. Whether changes to pin page may automatically trigger corresponding triggers to a company, product, etc., website or webpage, may depend on whether the website or webpage is part of (e.g., registered with, hosted by, etc.) the pin page platform.

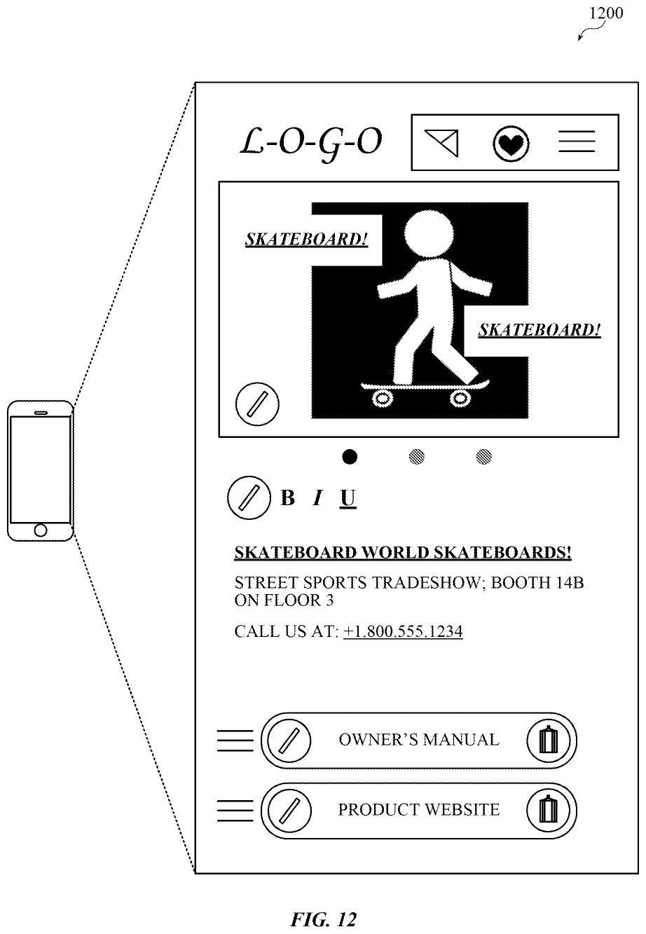

FIG. 12 is a diagram of an example user interface 1200 for managing a pin page according to one or more implementations described herein. User interface 1200 may be accessible to the owner of the pin page and may enable the owner of the pin page to add, edit, and delete feature of the pin page. As shown, the pin page of user interface 1200 may include many of the same features of pin page 1100 of FIG. 11. However, user interface 1200 may also include features for modifying the pin page. As shown, the image portion, the text portion, and the pressable buttons of the pin page may each include a pressable button or icon for editing the corresponding feature or area of the pin page. In some implementations, additional editing features or options may be included, such as a delete button or icon for each button (e.g., represented by a circle with a trashcan or similar image). As such, the pin page platform of pin page server 220 may enable the owner of a pin page to use UE 210 to add, edit, or delete pin page feature at any time, and immediate republish the pin page.

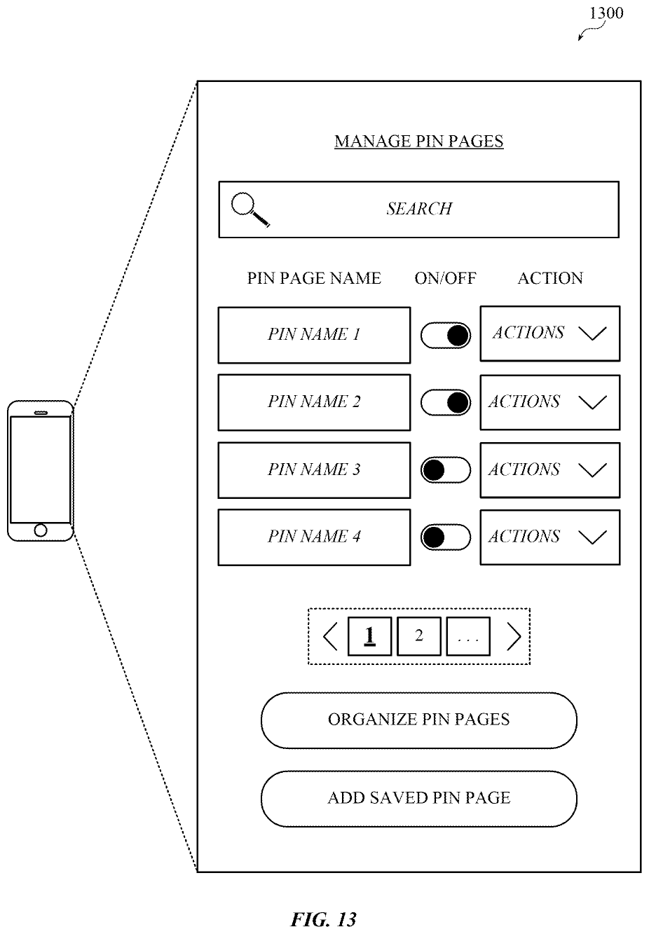

FIG. 13 is a diagram of an example user interface 1300 for managing multiple pin pages of a pin page account according to one or more implementations described herein. User interface 1300 may include one or more features to enable an owner or user of a pin page account to manage pin pages associated with the pin page account. As shown, examples of such features may include a search space that may be used to search for one or more pin pages based on a word, number, or another type of text entered into the search space. Additional examples may include a list of pin pages associated with the pin page account (e.g., pin name 1, pin name 2, etc.) and an interface object for manually scrolling or browsing through pin pages listed (e.g., a “previous list” arrow, a list or page number 1, 2, etc., a “next list” arrow, etc.) that are not currently displayed in user interface 1300. Additionally, or alternatively, each pin name may be associated with an action selectable from a dropdown menu and a corresponding slide button (or another type of interface object, such as a toggle button) that may indicate whether the selected action is on or off, enabled or disabled, etc. For example, an owner of the pin page account may identify a pin page of interest (e.g., pin page 2), select an action (e.g., publish) and use the slide button to control whether the pin page is published or not. In some implementations, a slide button may not be used for one or more, or any, actions of the dropdown menu. Additional examples of an action may include viewing the pin page, duplicating the pin page, pin page analytics, editing a pin page, deleting a pin page, and more.

User interface 1300 may also include one or more pressable buttons. Examples of such buttons and functions may include a button to enable the owner of the pin page account to organize the pin pages in a different way (e.g., ascending or descending—by creation date, by date range(s), by name, by user traffic, by sales, by potential customer inquiries, by tradeshow, by tradeshow booth, etc.). In some implementations, additional or alternative features for managing pin pages may be provided and enabled by the pin page platform. Another example of a button and corresponding function may include a button to enable the user to create a new pin page (e.g., see FIGS. 7-10 and the corresponding descriptions). As such, the pin page platform (which may include a pin page mobile application, web hosting services, backend functions, and data storage processes described herein) may enable a user to create a pin page account, create product- and tradeshow-specific pin pages, associate the pin pages with customized QR codes, and actively manage the pin pages during the tradeshow (e.g., publish pin pages, unpublish pin pages, update, edit, delete pin page content, etc.).

Referring to FIG. 5, process 500 may also include specifying and accessing pin page activity information. For example, UE 210 may communicate with pin page server 220 to enable a pin page account owner to specify whether and/or which types of pin page activity information may be collected by pin page server 220 of the pin page platform. Example of pin page activity information may include a wide variety of user activity and traffic information. As non-limiting example of some types of pin page activity information may include number of pin page visits, a date and time of a pin page visit, a duration for which a pin page was visited, actions taken by a user while accessing a pin page (e.g., images viewed, buttons pressed, etc.), instances where the pin page was saved by a user, times a pin page was “liked”, instances where the pin page was shared with another user, non-personal or user approved profile information of a user accessing the pin page or a user with whom a pin page was shared, an employee or presenter at the corresponding location (e.g., a tradeshow booth) at the time the pin page was accessed, etc.

In some implementations, the pin page activity information may be specific to one pin page, a group of pin pages (e.g., pin pages pertaining to a particular product, service, or tradeshow), applicable to all pin pages of the pin page account. In some implementations, the pin page activity information may also, or alternatively, be specific to one or more dates, times, amounts, pin page visitor profile information, types of pin page activity, etc.). In some implementations, some or all pin page activity information may be collected by the pin page platform by default (e.g., regardless of whether the activity information is specified.

Additionally, or alternatively, pin page platform may also provide a pin page account owner with options to specify how pin page activity information may be processed (e.g., to produce more insightful metrics based on synthesizing more basic metrics, such as pin page visits relative to time) and displayed (e.g., as raw data; in a list format; in a graph format; etc.). In some implementations, a pin page account owner may also, or alternatively, specify triggers, responses, and/or prompts corresponding to pin page activity information. For example, the pin page platform may enable a pin page account owner to specify a promotion challenge, such as 100 unique users visiting a particular pin page, that triggers a response, such as a sale or product give away of the corresponding product, and a prompt or push notification to one or more users (e.g., users that had visited the pin page, users that registered their contact information through the pin page, tradeshow attendees registered with the pin page platform, users that satisfy one or more types of user profile characteristics, etc.).

Another example of triggers and responses may include a message being sent to the pin page account owner if/when one or more types (or combinations) of pin page activity exceeds a pre-defined threshold (e.g., a threshold number of product orders have been received). UE 210 may also communicate with pin page server 220 to enable the pin page account owner to access the pin page activity information collected and processed by the pin page platform. This may include providing the pin page account owner with information of any variety of types or formats, including text, lists, graphs, images, etc. In some implementations, the pin page platform may be configured to push prompts (e.g., short message service (SMS) messages, notifications within the pin page mobile application, voice calls, etc.) to a pin push account owner and/or other users of the pin page platform”).

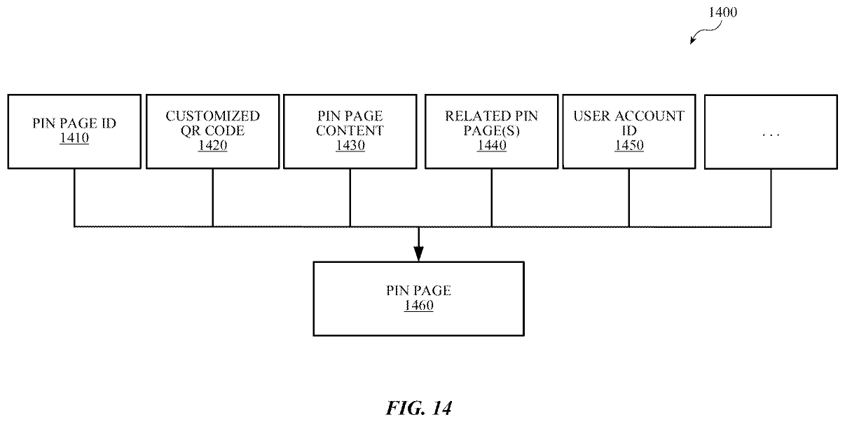

FIG. 14 is a diagram of an example data structure 1400 of a pin page according to one or more implementations described herein. Data structure 1400 may include a broad example of the types of information that may be included in, or logically associated with, a pin page as described herein. Additionally, any of data structure 1400 may be stored by UE 210, pin page server 220, and/or data repository 230 to implement one or more of the techniques described herein. For example, pin page server 220 may create data structure 1400 during the pin page creation process and cause data structure 1400 to be stored in data repository 230.

Additionally, pin page server 220 may provide data structure 1400 to UE 210 when pin page 1460 is accessed by a user (e.g., the pin page account owner or a pin page visitor). In some implementations, data structure 1400 may include one or more fewer, additional, differently ordered, and/or arranged types of information than those shown in FIG. 14. For example, in some implementations, an example data structure of a pin page may include related webpages (e.g., product webpages, company webpages, etc.) instructions for pin page activity information tracking, processing, presenting, thresholds, triggers, and responses related to pin page activity information, etc. As such, data structure 1400 is provided as non-limiting example of information that may be used to implement one or more of the techniques described herein.

As shown, data structure 1400 of pin page 1460 may include a pin page ID 1410, a customized QR code 1420, pin page content 1430, related pin pages 1440, a user account ID, and/or one or more types of information. Pin page ID 1410 may include a sequence of alphanumeric characters, a grouping of data set or database record attributes (e.g., QR code ID combined with a user account ID), and/or one or more other types of information, or information sets, capable of uniquely identifying pin page 1460 from other pin pages. Customized QR code 1420 may be identified using a QR code ID and may include a QR code pattern that has been modified in one or more ways, such as changing colors of the QR code (e.g., from white and black to white and green), shapes used in the QR code (e.g., changing squares to circles), and/or inserting one or more objects into or above the QR code (e.g., a logo, image, or text inserted into or above a middle area of the QR code). A customized QR code may enable the QR code to appear more germane to the subject, product, or service of a pin page without freighting the functionality of the QR code being scannable by UE 210.

Pin page content 1430 may include one or more types of page layouts, formats, text, images, videos, interface objects (e.g., checkboxes, dropdown menus, buttons, links, payment portals (e.g., to Venmo®, Cash App®, etc.). Pin page content 1430 may relate to a product, service, event, organization, promotion, issues, or other subject of interest to the corresponding pin page account owner and/or potential pin page visitors. Examples of pin page content are provided throughout this description.

Related pin pages 1440 may include one or more other pin pages that are related to pin page 1460. Related pin pages 1440 may include pin pages belonging to the same pin page account of pin page 1460. Related pin pages 1440 may also, or alternatively, include pin pages that have been logically associated with pin page 1460 in one or more other ways. For example, pin page content 1430 may include links or buttons that cause a user visiting pin page 1460 to move to the inked pin page and/or cause the user of pin page 1460 to be provided with a list of pin pages, designated as being related to pin page 1460, from which the user may select and visit one or more of the listed pin pages. Related pin pages 1440 may be designated by the user that owns or created pin page 1460 and/or by another user (e.g., through an interface object of pin page 1460 that enables non-owner users to link related pin pages 1440 to pin page 1460). As such, related pin pages 1440 may involve a web or network of logically linked pin pages to facilitate a user discovering and moving between pin pages.

User account ID 1450 may include a sequence of alphanumeric characters, an email address, a username, a grouping of data set or database record attributes (e.g., pin page ID combined with a QR code ID), and/or one or more other types of information, or information sets, capable of identifying a pin page account from other pin page accounts. In some implementations, the pin page account may be associated with multiple pin pages 1460. Additionally, or alternatively, pin page 1460 may be associated with multiple user account IDs 1450. For example, multiple users may be designated with administrative privileges of pin page 1460, such that multiple users may manage (e.g., add to, edit, and/or delete content) pin page 1460. In such implementations, this may be achieved by associating multiple user account IDs (or user IDs) with pin page 1460.

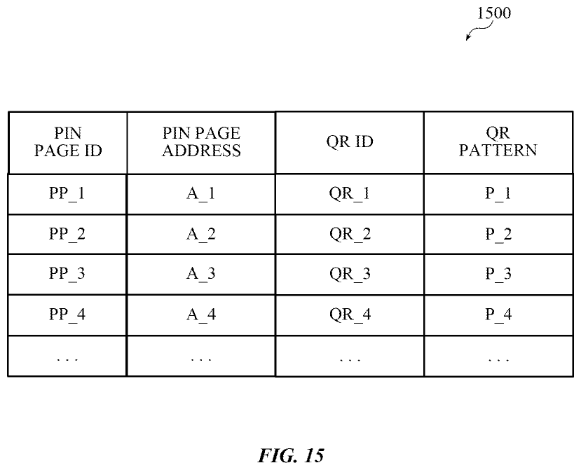

FIG. 15 is a diagram of an example data structure for associating customized QR codes with pin pages according to one or more implementations described herein. Any, and/or all, of data structure 1500 may be stored by UE 210, pin page server 220, and/or data repository 230 to implement one or more of the techniques described herein. For example, pin page server 220 may create data structure 1500 during the pin page creation process and cause data structure 1500 to be stored in data repository 230. And, for example, as new pin pages are created, pin page server 220 may use data structure 1500, and or a version thereof, to verify that a QR code to be associated with the new pin pages are not already associated with an existing pin page.

In some implementations, data structure 1500 may include one or more fewer, additional, differently ordered, and/or arranged types of information than those shown in FIG. 15. For example, in some implementations, an example data structure of a pin page may include related webpages (e.g., product webpages, company webpages, etc.) instructions for pin page activity information tracking, processing, precenting, thresholds, triggers, and responses related to pin page activity information, etc. As such, data structure 1500 is provided as non-limiting example of information that may be used to implement one or more of the techniques described herein.

As shown, data structure 1500 may include records that each include multiple attributes, such as a pin page ID, a pin page address, a QR ID, and a QR pattern. Each record may correspond to a different pin page, indicate by the pin page ID. The pin page ID may be associated with a pin page address, which may include a URL or another type of information indicating a location of pin page information, such as data structure 1400 of FIG. 14. A QR ID may include a sequence of alphanumeric characters and/or one or more other types of information, or information sets, capable of identifying a QR code. Each QR ID may be associated with a QR pattern, which may include a pattern of visually contrasting shapes (e.g., black and white boxes or dots) that UE 210 may scan and decode, and thereby access information (e.g., a pin page) associated with the QR code.

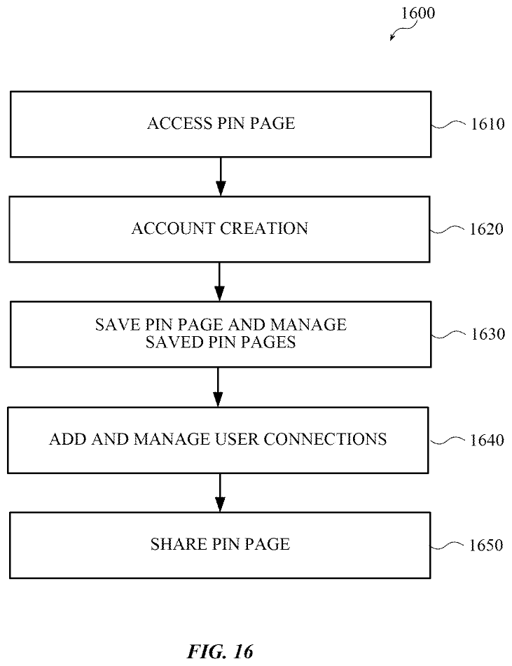

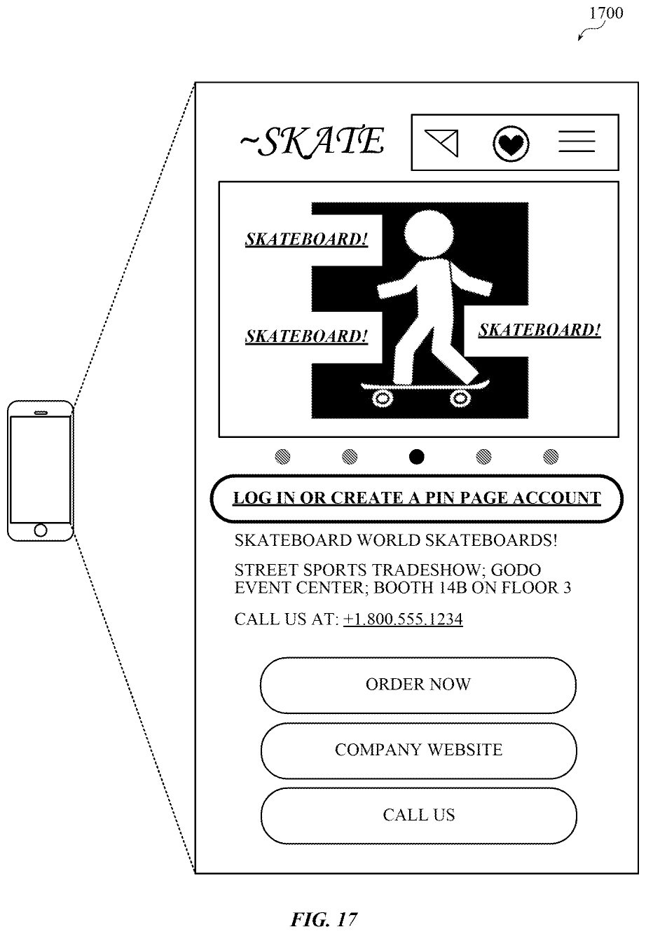

FIG. 16 is a diagram of an example process 1600 for accessing and interacting with a pin page according to one or more implementations described herein. Process 1600 may be implemented by UE 210. In some implementations, some or all of process 1600 may be performed by one or more other systems or devices, including one or more of the devices of FIG. 2. Additionally, process 1600 may include one or more fewer, additional, differently ordered and/or arranged operations than those shown in FIG. 16. In some implementations, some or all of the operations of process 1600 may be performed independently, successively, simultaneously, etc., of one or more of the other operations of process 1600. As such, the techniques described herein are not limited to a number, sequence, arrangement, timing, etc., of the operations or process depicted in FIG. 16. Process 1600 is described below with periodic reference to FIGS. 17-20.

As shown, process 1600 may include accessing a pin page (block 1600). For example, UE 210 may communicate with pin page server 220 to access a pin page. UE 210 may scan a customized a customized QR code, decode the QR code into a URL (or another type of location indicator) corresponding a pin page, and access the pin page via a pin page application installed on UE 210, a browser application, or another means.

FIG. 17 is a diagram of an example of a pin page 1700 according to one or more implementations described herein. In some implementations, one or more of the features pin page 1700 may be provided via one or more additional or alternative webpages or user interfaces. Additionally, one or more of the features of pin page 1700 may include fewer, additional, differently ordered and/or arranged features than those shown in FIG. 17. The example of pin page 1700 is a non-limiting example of a pin page that may be involved in one or more implementations described herein.

Pin page 1700 may include one or more features similar to those described above with reference to FIG. 11. Pin page 1700 of FIG. 17 may include features and information designated by a user during the creation of the pin page. Examples of such features and information may include a logo (e.g., “—Skate”), an area displaying an image (e.g., an individual on a skateboard with the words “Skateboard!”), and a prompt (e.g., circles below the image) for a pin page visitor to scroll between additional images of the pin page. Additional examples may include text and executable links to information, such as “Skateboard World Skateboards!”, a description of the tradeshow (e.g., “Street Sports Tradeshow”), a location of the tradeshow (e.g., the “Good Event Center” and “Booth 14B on Floor 3”), and contact information.

Pin page 1700 may also include buttons that a user viewing the pin page may press to, for example, order a corresponding product (e.g., a skateboard), visit the company's website, and/or contact the person or organization in charge of the pin page. Published pin page 110 may also include pressable buttons for sharing the pin page with other users via SMS message, an in-app prompt, an email, or social media platforms etc. As shown, the button or icon for sharing the pin page may include an arrow-like or triangular icon of pin page 1700. Pin page 1700 may also include a button or icon for saving, or including, the pin page in a list of pin page favorites (e.g., indicated by a heart symbol of pin page 1700), and an options icon (indicated by three horizonal lines). Examples of pin page options, a menu, etc., may include creating a brand account, accessing user account information, purchasing additional pin page services (e.g., additional pin pages), and accessing a favorites library (e.g., of pin pages previously identified by a user as being saved, “liked”, etc.

In some implementations, when the user has not registered with the pin page platform (e.g., has not created a pin page account) or when the user has an account but is not logged in to the pin page platform, pin page platform may prompt the user to create or account or log in. For example, as shown in FIG. 17, pin page 1700 may include a button or other prompt for the user to log in or create an account. In some implementations, pin page platform may provide this prompt by automatically inserting an interface object (e.g., the button) into the pin page itself. In some implementation, the prompt may be an overlay window or interface object above pin page 1700. In some implementations, pin page platform may route a request for pin page 1700 to another webpage that provides the user with the option of logging in, creating an account, or proceeding directly to pin page 1700.

Referring to FIG. 16, process 1600 may include creating an account (block 1620). For example, UE 210 may communicate with pin server 220 to create a pin page account. Processes, operations, and features for creating a pin page account are described above with reference to FIGS. 5-6. Without a pin page account, UE 210 may be able to view pin page 1700 and share pin page 1700 with non-registered users (e.g., via email, SMS message, direct message, etc.). With a pin page account, UE 210 may be able to access pin page 1700 and other pin page platform features described below, such as saving a pin page, adding, removing, and managing user connections, and sharing pin pages with users registered with the pin page platform (e.g., users with pin page accounts).

Process 1600 may include saving the pin page and managing saved pin pages (block 1600). For example, UE 210 may communicate with pin page server 220 to save a pin page to a pin page account of a user of UE 210. In some implementations, saving a pin page may be the same as adding the pin page to a list of favorite pin pages, indicating a preference for the pin page (e.g., via a “like” icon, a “thumbs up” icon, an upvote, save to a favorites folder, etc.). In some implementations, saving a pin page may be different than one or more of adding the pin page to a list of favorite pin pages or indicating a preference for the pin page. UE 210 may also communicate with pin page server 220 to manage saved pin pages.

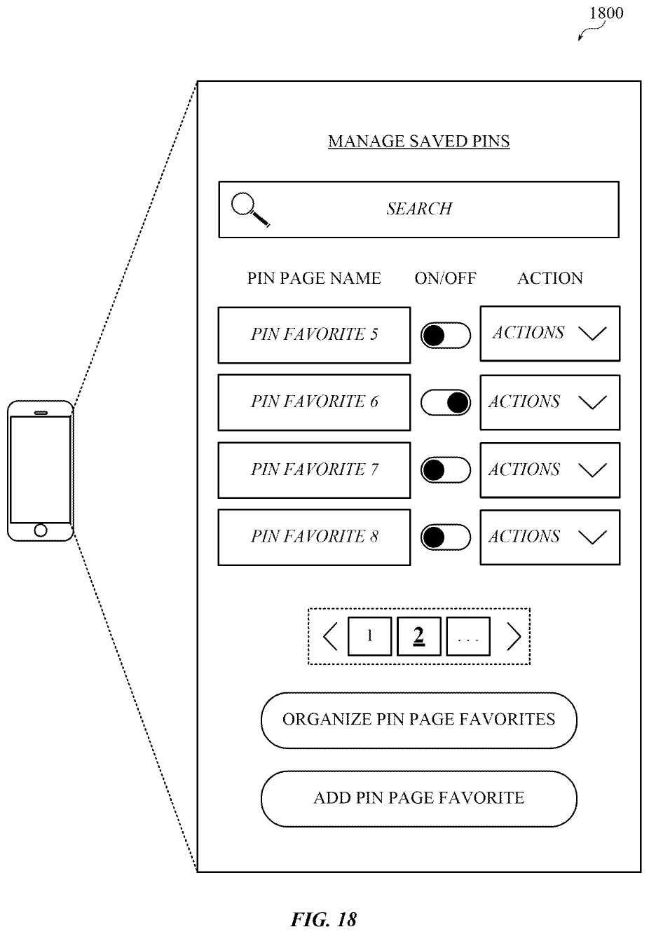

FIG. 18 is a diagram of an example user interface 1800 for managing saved pin pages according to one or more implementations described herein. In some implementations, one or more of the features of user interface 1800 may be provided via one or more additional or alternative user interfaces. Additionally, one or more of the features of user interface 1800 may include fewer, additional, differently ordered and/or arranged features than those shown in FIG. 18. The example of user interface 1800 is a non-limiting example of user interfaces that may be involved in one or more implementations described herein.

User interface 1800 may include one or more features to enable a user to manage pin pages that have been saved to a pin page account. As shown, examples of such features may include a search space that may be used to search for one or more pin pages based on a word, number, or another type of text entered into the search space. Additional examples may include a list of saved pin pages (e.g., pin favorite 5, pin favorite 6, etc.) and an interface object for manually scrolling or browsing saved pin pages that are not currently displayed in user interface 1800 (e.g., a “previous list” arrow, a list or page number 1, 2, etc., a “next list” arrow, endless scroll, etc.). Additionally, or alternatively, each pin name may be functionally associated with an action that is selectable from a dropdown menu and a corresponding slide button (or another type of interface object). The slide button may enable a user to activate/deactivate the action selected from the dropdown menu. For example, the selected action may concern privacy (e.g., whether other users may be made aware of the saved status of a particular pin page) and the corresponding slide button may be used to activate/deactivate the privacy status. Another example may include a selected action of whether owners of saved pin pages may contact the user and the corresponding slide button may be used to activate/deactivate this functionality. Yet another example of an action may be simply to delete a saved pin page, in which case the corresponding slide button may be irrelevant. In some implementations, a slide button may not be used for one or more, or any, actions of the dropdown menu. In some implementations, the slide or toggle button may turn a pin page “on or ‘off’” (e.g., for receiving direct messages, push messages, pin page update notifications, etc., from the visiting user perspective).

User interface 1800 may also include one or more pressable buttons. Examples of such buttons may include a button to enable the user to organize the saved pin pages in a different way (e.g., ascending or descending—by creation date, by date range(s), by name, by user traffic, by sales, by potential customer inquiries, by tradeshow, by tradeshow booth, etc.). Another example of a button may include a button to enable the user to add another pin page to the saved pin page. For example, if a user received an email, direct message, or SMS message that include a QR code or URL of another pin page, the user may use the add saved pin page button to directly include the pin page in the list of saved pin pages. Enabling a user to save pin pages and manage saved pin pages may help a consumer (e.g., a tradeshow attendee) create and maintain an organized record of the products, services, and displays of particular interest to the consumer.

Referring to FIG. 16, process 1600 may include adding and managing user connections (block 1600). For example, UE 210 may communicate with pin page server 220 to add and manage user connections between pin page accounts of the pin page platform. For example, when a user at a tradeshow meets a person of interest at a tradeshow, the pin page platform may be used to create a connection between the pin page accounts of each user. In some implementations, a pin page account may correspond to a person. In some implementations, a pin page account may correspond to an organization or another type of entity, such as a business. User connections may be created by entering user account information (e.g., a name, username, email, etc.) into UE 210 and causing pin page platform to send a connection invitation message to the pin page account corresponding to the entered information. In response to the invitation being accepted by the receiving account, the pin page platform may add a record of the user connection in a user connection management interface of each pin page account.

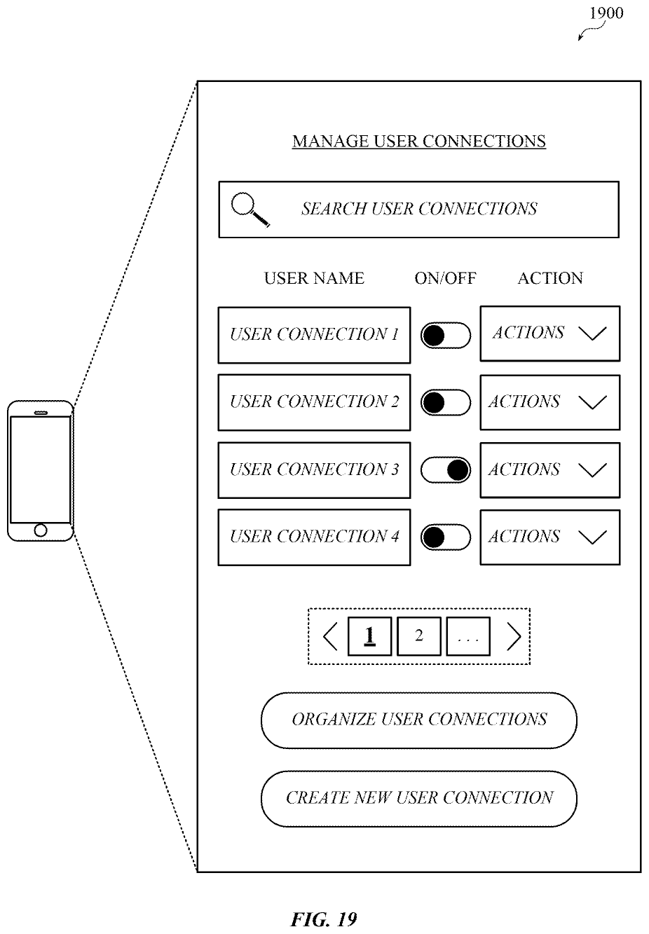

FIG. 19 is a diagram of an example user interface 1900 for managing user connections according to one or more implementations described herein. In some implementations, one or more of the features of user interface 1900 may be provided via one or more additional or alternative user interfaces. Additionally, one or more of the features of user interface 1900 may include fewer, additional, differently ordered and/or arranged features than those shown in FIG. 19. The example of user interface 1900 is a non-limiting example of user interfaces that may be involved in one or more implementations described herein.

User interface 1900 may include one or more features to enable a user to manage user connections of a pin page account. As shown, examples of such features may include a search space that may be used to search for one or more user connections based on a word, number, or another type of text entered into the search space. Additional examples may include a list of active user connections (e.g., user connection 1, user connection 2, etc.) and an interface object for manually scrolling or browsing active user connections that are not currently displayed in user interface 1900 (e.g., a “previous list” arrow, a list or page number 1, 2, etc., a “next list” arrow, etc.). Additionally, or alternatively, each pin name may be functionally associated with an action that is selectable from a dropdown menu and a corresponding slide button (or another type of interface object). In some implementations, the toggle may turn the pin page on or off.

In some implementations, the selected action may concern privacy (e.g., whether the user connection may be visible to other pin page accounts or used by the pin page platform for analysis and data processing) and the corresponding slide button may be used to activate/deactivate the privacy status of the user connection. Another example may include whether an online or active status of one user may be visible to the other user of the user connection and the corresponding slide button may be used to activate/deactivate this functionality. Another example may include a selected action of whether, and/or how, a user of a user connection may contact the user of the pin page account and the corresponding slide button may be used to activate/deactivate this functionality. Yet another example of an action may be simply to delete a saved pin page, in which case the corresponding slide button may be irrelevant. In some implementations, a slide button may not be used for one or more, or any, actions of the dropdown menu. For example, an action may be to view the contact information or send a direct message to a user connection, which may not require or involve an interface object to disable/enable the action.

User interface 1800 may also include one or more pressable buttons. Examples of such buttons may include a button to enable the user to organize the saved pin pages in a different way (e.g., ascending or descending—by creation date, by date range(s), by name, by user traffic on a pin page of the pin page account, by sales, by potential customer inquiries, by tradeshow, by tradeshow booth, etc.). Another example of a button may include a button to enable the user to add another user connection to the current user connection, which may include inputting a name, email address, username, etc., of the target connection, sending the target connection a connection invitation, and receiving a response thereto. As such, techniques described herein may include solutions for users of the pin page platform to create connections, which may include, for example, an ability of one user to follow one or more pin pages of another user.

Referring to FIG. 16, process 1600 may include sharing a pin page (block 1650). For example, UE 210 may communicate with pin page server 220 to enable a user to share a pin page. In some implementations, a user viewing a pin page may press a share button or icon displayed on the pin page. The pin page platform may respond by prompting the user to enter contact information for sharing the pin page. In some implementations, this response may not require a user to be logged in, or registered with, the pin page platform. Examples of such information may include a name, email, username, phone number, etc., depending on one or more factors, such as whether the pin page is to be shared with a user of another pin page account or a user without a pin page account. For example, when the target user has a pin page account, the user may enter a username of the target user, select the target user from a list of user connections, etc. Additionally, or alternatively, when the target user does not have a pin page account, the user may enter a phone number, an email address, etc., for sharing the pin page. Accordingly, techniques described herein may enable users to view pin pages, create pin page accounts, save, and manage pin pages, create and manage user connections, and share pin pages with users regardless of whether the user has a pin page account.

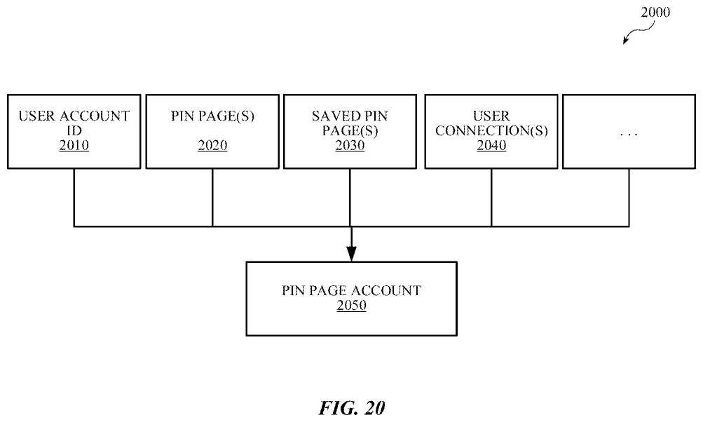

FIG. 20 is a diagram of an example data structure 2000 of a pin page account according to one or more implementations described herein. Data structure 2000 may include a broad example of the types of information that may be included in, or logically associated with, a pin page account as described herein. Additionally, any of data structure 2000 may be stored by UE 210, pin page server 220, and/or data repository 230 to implement one or more of the techniques described herein. For example, pin page server 220 may create data structure 2000 during the pin page creation process and cause data structure 2000 to be stored in data repository 230. Additionally, pin page server 220 may provide some or all of data structure 2000 to UE 210 when a user requests to view, update, and/or delete the pin page account. In some implementations, data structure 2000 may include one or more fewer, additional, differently ordered, and/or arranged types of information than those shown in FIG. 20. As such, data structure 2000 is provided as non-limiting example of information that may be used to implement one or more of the techniques described herein. As shown, data structure 2000 of pin page account 2060 may include user account ID 2010, one or more pin pages 2020, saved pin pages 2030, user connections 2040, and/or one or more types of information. Examples of user account IDs, pin pages, saved pin pages, and user connections are described above with reference to one or more of the preceding figures.

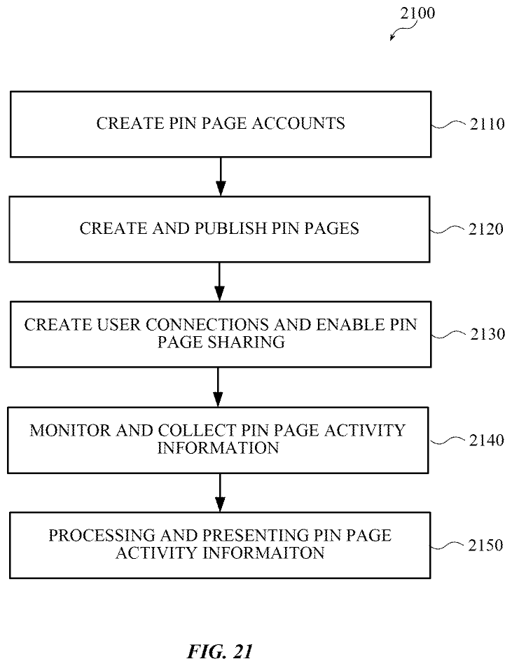

FIG. 21 is a diagram of an example process 2100 for managing a pin page platform according to one or more implementations described herein. Process 2100 may be implemented by pin page server 220. In some implementations, some or all of process 2100 may be performed by, or in combination with, one or more other systems or devices, including one or more of the devices of FIG. 2, such as UE 210. Additionally, process 2100 may include one or more fewer, additional, differently ordered and/or arranged operations than those shown in FIG. 21. In some implementations, some or all of the operations of process 2100 may be performed independently, successively, simultaneously, etc., of one or more of the other operations of process 2100. As such, the techniques described herein are not limited to a number, sequence, arrangement, timing, etc., of the operations or process depicted in FIG. 21. Further, some processes, operations, and features described herein may be described in the context of being performed by a pin page platform. In some implementations, such processes, operations, or features may be applicable to process 2110 and performed by pin page server 220.

As shown, process 2100 may include creating pin page accounts (block 2110). For example, pin page server 220 may communicate with UE 210 to create a pin page account for a user of UE 210. The pin page account may be based on input provided by the user via UE 210. Examples of creating pin page accounts are described above with reference to the preceding figures. Process 2100 may also include creating and publishing pin pages (block 2120). For example, pin page server 220 may receive instructions and information from UE 210 for creating a pin page, and pin page server 220 may process the information to generate a data structure defining a pin page. Pin page server 220 may also, or alternatively, publish a pin page, which may include hosting or otherwise making the pin page available to UEs 210. Additional examples and details of creating and publishing pin pages are described above with reference to the preceding figures.

Process 2100 may also include creating user connections and enabling pin page sharing (block 2130). For example, pin page server 220 may receive information and requests from UE 210 to create a user connection between pin page accounts. The information and requests may be part of a series of messages, supported and enabled by pin page server 220, between pin page accounts, such as an invitation from one pin page account to another and an affirmation in response thereto. The user connection may enable user of the pin page accounts to send direct messages to one another, view profile information, and/or one or more other pin page platform permissions. Pin page server 220 may also enable or support pin page sharing, which may include a receiving a request from one UE 210 to share a QR code, URL, etc., of a particular pin page with another user (e.g., via SMS message, email, direct message, etc.). Additional examples and details for creating user connections and enabling pin page sharing are described above with reference to the preceding figures.

Process 2100 may also include monitoring and collecting pin page activity information (block 2140). For example, pin page server 220 may execute one or more processes to monitor and collect information about pin page accounts, pin pages, user interactions with pin pages, pin page sharing, user connections, and/or one or more other types of pin page platform activity. Examples of pin page activity information may include a wide variety of user activity and traffic information. As non-limiting example of some types of pin page activity information may include number of pin page visits, a date and time of a pin page visit, a duration for which a pin page was visited, actions taken by a user while accessing a pin page (e.g., images viewed, buttons pressed, etc.), instances where the pin page was saved by a user, times a pin page was “liked”, instances where the pin page was shared with another user, non-personal or user approved profile information of a user accessing the pin page or a user with whom a pin page was shared, an employee or presenter (e.g. at a corresponding tradeshow booth) at the time the pin page was accessed, etc. Additional examples and details of monitoring and collecting pin page activity information are described above with reference to the preceding figures.

Processing 2100 may include processing and presenting pin page activity information (block 2150). For example, pin page server 220 may process pin page activity information in one or more ways and present the pin pages activity, and/or results of the processing, to a user. In some implementations, pin page server 220 may provide a pin page account owner with options to specify how pin page activity information may be processed (e.g., to produce more insightful metrics based on synthesizing more basic metrics, such as pin page visits relative to time) and displayed (e.g., as raw data; in a list format; in a graph format; etc.). In some implementations, pin page server 220 may also, or alternatively, implement triggers, responses, and/or prompts (specified by pain page account owner). For example, pin page server 220 may enable a pin page account owner to specify a promotion challenge, such as 100 unique users visiting a particular pin page, that triggers a response, such as a sale or product give away of the corresponding product and send a corresponding prompt or push notification to one or more users when the promotion challenge is complete. Additional examples and details of monitoring and collecting pin page activity information are described above with reference to the preceding figures.

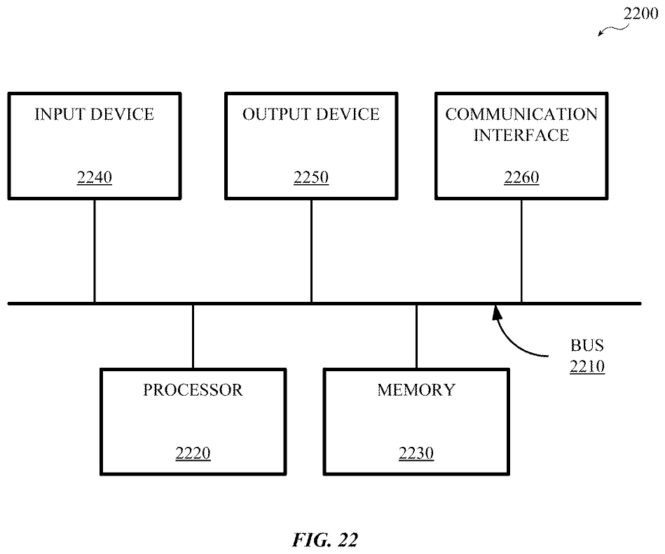

FIG. 22 is a diagram of example components of a device 2200 that may be used within environment 200 of FIG. 2. Device 2200 may correspond to UE 210, pin page server 220, and/or platform management terminal 240. Each of UE 210, pin page server 220, and/or platform management terminal 240 may include one or more of devices 2200 and/or one or more of the components of device 2200.

As depicted, device 2200 may include bus 2210, processor 2220, memory 2230, input device 2240, output device 2250, and communication interface 2260. However, the precise components of device 2200 may vary between implementations. For example, depending on the implementation, device 2200 may include fewer components, additional components, different components, or differently arranged components than those illustrated in FIG. 22.

Bus 2210 may permit communication among the components of device 2200. Processor 2220 may include one or more processors, microprocessors, data processors, co-processors, network processors, application-specific integrated circuits (ASICs), controllers, programmable logic devices (PLDs), chipsets, field-programmable gate arrays (FPGAs), or other components that may interpret or execute instructions or data. Processor 2220 may control the overall operation, or a portion thereof, of device 2200, based on, for example, an operating system (not illustrated), and/or various applications. Processor 2220 may access instructions from memory 2230, from other components of device 2200, or from a source external to device 2200 (e.g., a network or another device).

Memory 2230 may include memory and/or secondary storage. For example, memory 2230 may include random access memory (RAM), dynamic RAM (DRAM), read-only memory (ROM), programmable ROM (PROM), flash memory, or some other type of memory. Memory 2230 may include a hard disk (e.g., a magnetic disk, an optical disk, a magneto-optic disk, a solid state disk, etc.) or some other type of computer-readable medium, along with a corresponding drive. A computer-readable medium may be defined as a non-transitory memory device. A memory device may include space within a single physical memory device or spread across multiple physical memory devices.

Input device 2240 may include one or more components that permit a user to input information into device 2200. For example, input device 2240 may include a keypad, a button, a switch, a knob, fingerprint recognition logic, retinal scan logic, a web cam, voice recognition logic, a touchpad, an input port, a microphone, a display, or some other type of input component. Output device 2250 may include one or more components that permit device 2200 to output information to a user. For example, output device 2250 may include a display, light-emitting diodes (LEDs), an output port, a speaker, or some other type of output component.

Communication interface 2260 may include one or more components that permit device 2200 to communicate with other devices or networks. For example, communication interface 2260 may include some type of wireless or wired interface. Communication interface 2260 may also include an antenna (or a set of antennas) that permit wireless communication, such as the transmission and reception of radio frequency (RF) signals.

As described herein, device 2200 may perform certain operations in response to processor 2220 executing software instructions contained in a computer-readable medium, such as memory 2230. The software instructions may be read into memory 2230 from another computer-readable medium or from another device via communication interface 2260. The software instructions contained in memory 2230 may cause processor 2220 to perform one or more processes described herein. Alternatively, hardwired circuitry may be used in place of, or in combination with, software instructions to implement processes described herein. Thus, implementations described herein are not limited to any specific combination of hardware circuitry and software.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the example described herein, a user equipment (UE) may comprise: a memory; and one or more processors configured, when executing instructions stored in the memory, to: create, based on user input, a pin page regarding a product or service; create, based on the user input, a customized quick response (QR) code; cause the pin page to be associated with the customized QR code to enable UEs to access the pin page by scanning the customized QR code; and provide a user interface to enable changes to the pin page.

In example 2, which may also include one or more of the example described herein, wherein the one or more processors are further configured to: create, based on the user input, a pin page account prior to creating the pin page, wherein the pin page account is associated with a plurality of pin pages, and wherein each pin page, of the plurality of pin pages, being associated with a unique customized QR code.

In example 3, which may also include one or more of the example described herein, wherein the one or more processors are further configured to: create, based on the user input, a pin page account prior to creating the pin page; access a different pin page by scanning a customized QR code associated with the different pin page; and save the different pin page to the pin page account.

In example 4, which may also include one or more of the example described herein, wherein the one or more processors are further configured to: create, based on the user input, a pin page account prior to creating the pin page; access a different pin page by scanning a customized QR code associated with the different pin page; and share the different pin page with a different UE.

In example 5, which may also include one or more of the example described herein, wherein the different pin page is shared with a different pin page account.

In example 6, which may also include one or more of the example described herein, wherein the one or more processors are further configured to: create, based on the user input, a pin page account prior to creating the pin page; and create a user connection between the pin page account and a different pin page account.

In example 7, which may also include one or more of the example described herein, wherein the one or more processors are further configured to: cause the pin page to be published upon creation of the pin page.

In example 8, which may also include one or more of the example described herein, wherein the customized QR code comprises colors, shapes, contact information, and a logo specified by the user input.

In example 9, which may also include one or more of the example described herein, wherein the pin page comprises a logo, at least one image, and text corresponding to the product or service and specified by the user input.

In example 10, which may also include one or more of the example described herein, a server device may comprise: a memory; and one or more processors configured, when executing instructions stored in the memory, to: create, based on user input from a user equipment (UE), a pin page account; create, based on the user input from the UE, a pin page associated with the pin page account; create, based on the user input from the UE, a customized quick response (QR) code; associate the pin page with the customized QR code; and cause the pin page to be accessible via the QR code.

In example 11, which may also include one or more of the example described herein, wherein the one or more processors are further configured to: create a user connection between the pin page account and a different pin page account.

In example 12, which may also include one or more of the example described herein, wherein the one or more processors are further configured to: cause pin page to be shared with at least one other UE.

In example 13, which may also include one or more of the example described herein, wherein the one or more processors are further configured to: update, based on additional user input from the UE, the pin page account.

In example 14, which may also include one or more of the example described herein, a method, performed by a user equipment (UE), may comprise creating, based on user input, a pin page regarding a product or service; creating, based on the user input, a customized quick response (QR) code; causing the pin page to be associated with the customized QR code to enable UEs to access the pin page by scanning the customized QR code; and providing a user interface to enable changes to the pin page.

In example 14, which may also include one or more of the example described herein, a method, performed by a server device may comprise: a memory; and one or more processors configured, when executing instructions stored in the memory, to: creating, based on user input from a user equipment (UE), a pin page account; creating, based on the user input from the UE, a pin page associated with the pin page account; creating, based on the user input from the UE, a customized quick response (QR) code; associating the pin page with the customized QR code; and cause the pin page to be accessible via the QR code.

Example 14, which may also include one or more of the example described herein, may include a non-transitory computer-readable medium comprising: instructions stored by a memory device that when executed by one or more processors, may cause the processors to perform one or more of the examples described herein.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

1. A user equipment (UE), comprising:
a memory; and
one or more processors configured, when executing instructions stored in the memory, to:
create, based on user input, a pin page regarding a product or service;
create, based on the user input, a customized quick response (QR) code by generating at least one of: a shape, a logo, an image, a message or a colored feature to the customized QR code;
cause the pin page to be associated with the customized QR code to enable UEs to access the pin page by scanning the customized QR code; and
provide a user interface to enable changes to the pin page and features to the customized QR code.

2. The UE of claim 1, wherein the one or more processors are further configured to:
create, based on the user input, a pin page account prior to creating the pin page,
wherein the pin page account is associated with a plurality of pin pages, and
wherein each pin page, of the plurality of pin pages, being associated with a unique customized QR code.

3. The UE of claim 1, wherein the one or more processors are further configured to:
create, based on the user input, a pin page account prior to creating the pin page;
access a different pin page by scanning a customized QR code associated with the different pin page; and
save the different pin page to the pin page account.

4. The UE of claim 1, wherein the one or more processors are further configured to:
create, based on the user input, a pin page account prior to creating the pin page;
access a different pin page by scanning a customized QR code associated with the different pin page; and
share the different pin page with a different UE.

5. The UE of claim 4, wherein the different pin page is shared with a different pin page account.

6. The UE of claim 1, wherein the one or more processors are further configured to:
create, based on the user input, a pin page account prior to creating the pin page; and
create a user connection between the pin page account and a different pin page account.

7. The UE of claim 1, wherein the one or more processors are further configured to:
cause the pin page to be published upon creation of the pin page.

8. The UE of claim 1, wherein the customized QR code comprises at least one of: colors, shapes, contact information, the message, or the logo specified by the user input that is automatically inserted into the customized QR code by a pin page platform based on information provided in the pin page.

9. The UE of claim 1, wherein the pin page comprises a logo, at least one image, and text corresponding to the product or service and specified by the user input.

10. A server device, comprising:
a memory; and
one or more processors configured, when executing instructions stored in the memory, to:
create, based on user input from a user equipment (UE), a pin page account;
create, based on the user input from the UE, a pin page associated with the pin page account;
create, based on the user input from the UE, a customized quick response (QR) code by generating at least one of: a shape, a logo, an image, a message or a colored feature to the customized QR code;
associate the pin page with the customized QR code; and
cause the pin page to be accessible via the QR code.

11. The server device of claim 10, wherein the customized QR code comprises colors, shapes, contact information, and a logo specified by the user input.

12. The server device of claim 10, wherein the pin page comprises a logo, at least one image, and text corresponding to a product or service and specified by the user input from the UE.

13. The server device of claim 10, wherein the one or more processors are further configured to:
create a user connection between the pin page account and a different pin page account.

14. The server device of claim 10, wherein the one or more processors are further configured to:
cause pin page to be shared with at least one other UE.

15. The server device of claim 10, wherein the one or more processors are further configured to:
update, based on additional user input from the UE, the pin page account.

16. A method, performed by a user equipment (UE), the method comprising:
creating, via a processor coupled to a memory of the UE, based on user input, a pin page regarding a product or service;
creating, via the processor coupled to the memory of the UE, based on the user input, a customized quick response (QR) code by generating at least one of: a shape, a logo, an image, a message or a colored feature to the customized QR code;
causing, via the processor coupled to the memory of the UE, the pin page to be associated with the customized QR code to enable UEs to access the pin page by scanning the customized QR code; and
providing, via the processor coupled to the memory of the UE, a user interface to enable changes to the pin page.

17. The method of claim 16, further comprising:
creating, based on the user input, a pin page account prior to creating the pin page, the pin page account is associated with a plurality of pin pages,
wherein each pin page, of the plurality of pin pages, being associated with a unique customized QR code.

18. The method of claim 16, further comprising:
creating, based on the user input, a pin page account prior to creating the pin page;
accessing a different pin page by scanning a customized QR code associated with the different pin page; and
saving the different pin page to the pin page account.

19. The method of claim 16, further comprising:
creating, based on the user input, a pin page account prior to creating the pin page;
accessing a different pin page by scanning a customized QR code associated with the different pin page; and
sharing the different pin page with a different UE.

20. The method of claim 16, further comprising:
creating, based on the user input, a pin page account prior to creating the pin page; and
creating a user connection between the pin page account and a different pin page account.
